(19) United States
(12) Patent Application Publication
(10) Pub. No.: US 2010/0176257 A1
(43) Pub. Date: Jul. 15, 2010

(54) TABLE LEG ASSEMBLY

(76) Inventor: Tuang-Hock Koh, Taichung City (TW)

Correspondence Address: Chien-Hui Su, P. O. Box 70-121 Taichung, Taichung City, 40899, TW

(21) Appl. No.: 12/353,985

(22) Filed: Jan. 15, 2009

(51) Int. Cl. F16M 11/20

(52) U.S. Cl. 248/188.7

(57) ABSTRACT

A table leg assembly includes an upright leg and two branch legs. The upright leg has two tubes longitudinally extended therefrom. Each tube has a joint member plugged into a lower end thereof. At least one positioning pin passes through the joint member. Each branch leg has a cylinder formed in one end thereof. The cylinder is coaxially connected to the tube. The cylinder has multiple positioning holes defined therein. The at least one positioning pin is corresponding to one of the multiple positioning holes and plugged into the corresponding one of the multiple positioning holes.

### BACKGROUND OF THE INVENTION

1. Field of the Invention

The present invention relates to a table, and more particularly to a table leg assembly.

2. Description of Related Art

A conventional table leg assembly in accordance with the prior art comprises an upright leg and a branch leg connected to the upright leg. The upright leg is adapted to be mounted to a tabletop. The branch leg is substantially perpendicular to the upright leg to stabilize the table. The middle of the branch leg has a plug slot for receiving the upright leg. A screw passes the middle of the branch leg and fastens with the upright leg.

The conventional branch leg has a determinate length and width for supporting the table and stabilizing the table. The longer and wider branch leg may provide more stability; however, the length and the width are limited due to the placing environment. Furthermore, the longer and wider branch leg increase the production cost.

The present invention has arisen to mitigate and/or obviate the disadvantages of the conventional table leg assembly.

### SUMMARY OF THE INVENTION

The main objective of the present invention is to provide an improved table leg assembly, in that the angle between the branch legs is adjustable to fit the user's need.

To achieve the objective, the table leg assembly includes an upright leg and two branch legs connected to the upright leg. The upright leg has two tubes longitudinally extended therefrom. Each tube has a joint member plugged into a lower end thereof. At least one positioning pin passes through the joint member. Each branch leg has a cylinder formed in one end thereof. The cylinder is coaxially connected to the tube. The cylinder has multiple positioning holes defined therein. The at least one positioning pin is corresponding to one of the multiple positioning holes and plugged into the corresponding one of the multiple positioning holes.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a table leg assembly in accordance with the present invention;

FIG. 2 is a partial enlarged exploded perspective view of the table leg assembly in accordance with the present invention;

FIG. 3 is an assembled view of the table leg assembly in accordance with the present invention;

FIG. 4 to FIG. 6 are top plane views of the table leg assembly, showing the different angles between two branch legs; and

FIG. 7 is an assembled perspective view of a second embodiment of a table leg assembly in accordance with the present invention.

### DETAILED DESCRIPTION OF THE INVENTION

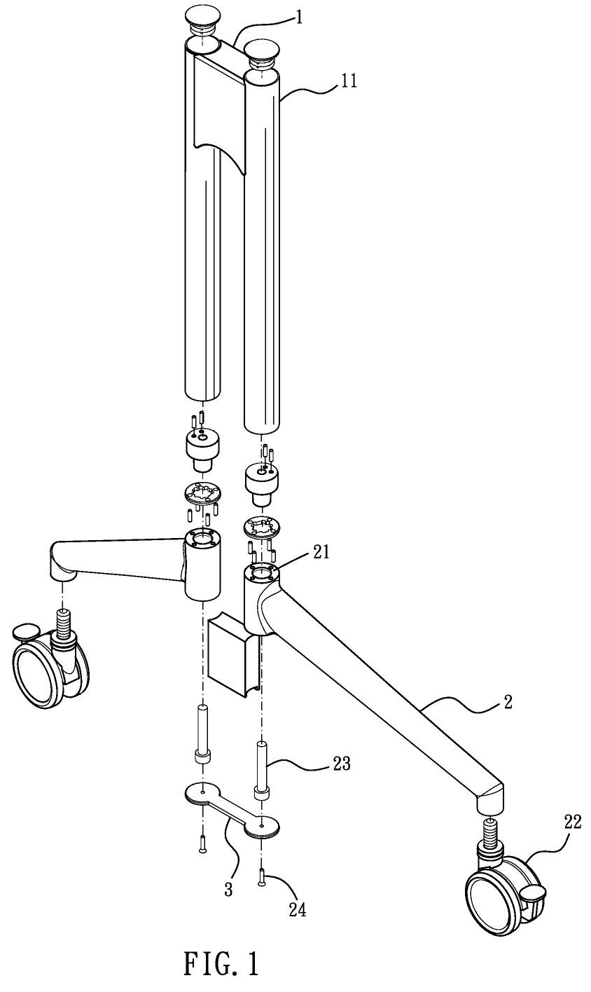

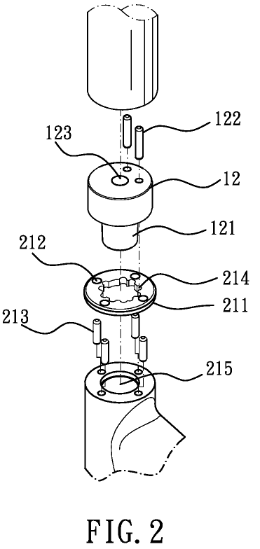

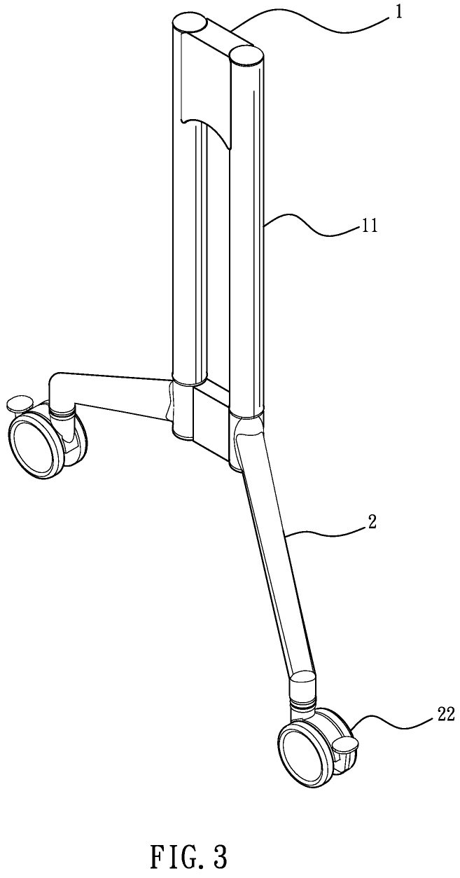

Referring to the drawings and initially to FIGS. 1-3, a table leg assembly in accordance with the present invention comprises an upright leg 1 and two branch legs 2 connected to the upright leg 1.

The upright leg 1 has two tubes 11 longitudinally extended therefrom. Each tube 11 is hollow. A joint member 12 is plugged into a lower end of each tube 11. The joint member 12 has a stub 121 centrally extended therefrom. The joint member 12 has a through hole 123 centrally defined therein. Each branch leg 2 has a cylinder 21 disposed in one end thereof for receiving the stub 121 such that the cylinder 21 is coaxially connected to the tube 11. The other end of each branch leg 2 has a roller 22. A ring 211 is disposed on a top of the cylinder 21. The ring 211 has multiple through holes 212 annularly defined therein. Multiple pins 213 pass through the multiple through holes 212 and the top of cylinder 21 of the branch leg 2 for securing the ring 211 on the top of the cylinder 21. The cylinder 21 has a receiving hole 215 centrally defined in the top thereof for receiving the stub 121 of the joint member 12. The stub 121 passes through the ring 211 and is plugged into the receiving hole 215. The ring 211 has multiple positioning holes 214 annular defined therein. At least one positioning pin 122 passes through the joint member 12. The at least one positioning pin 122 is corresponding to one of the multiple positioning holes 214 and plugged into the corresponding one of the multiple positioning holes 214.

The table leg assembly in accordance with the present invention further comprises two connecting pins 23 and a joint plate 3. Each connecting pin 23 passes through the cylinder 21 of the branch leg 2 and the ring 211 and is plugged into the through hole 123 in the joint member 12 such that the branch leg 2 is firmly connected to the upright leg 1. The joint plate 3 is disposed in a bottom of the cylinder 21. Two screws 24 pass the joint plate 3 and respectively fasten with one of the two connecting pins 23 for securing the two branch legs 2 and enhancing the rigidity of the table leg assembly.

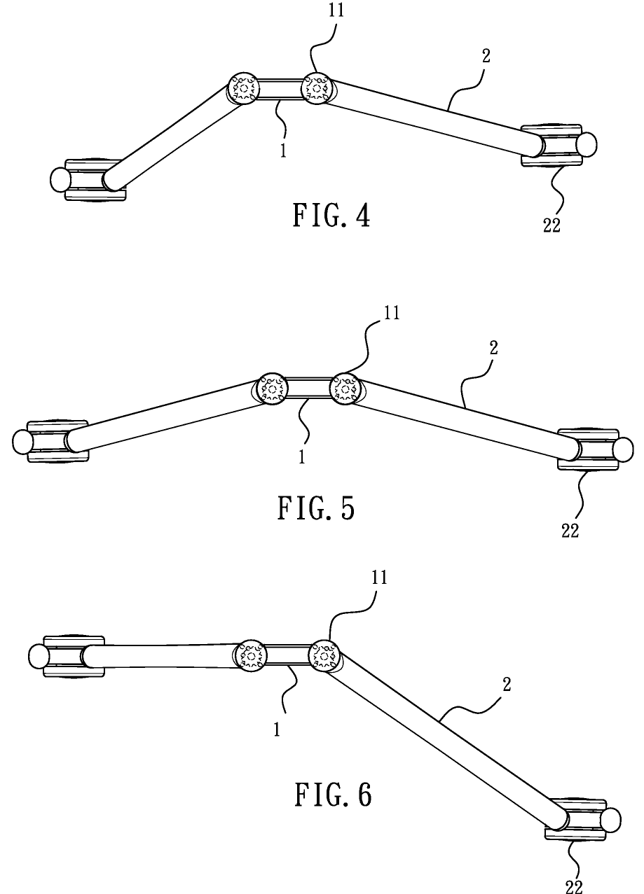

Referring to FIGS. 4-6, the different angles between two branch legs 2 are illustrated. When the at least one positioning pin 122 is plugged into the different corresponding one of the multiple positioning holes 214, an angle between two branch legs 2 is adjusted. Therefore, user can adjust the angle to fit their need. The table leg assembly in accordance with the present invention can fit different placing environments such that the production cost and inventory cost can be reduced.

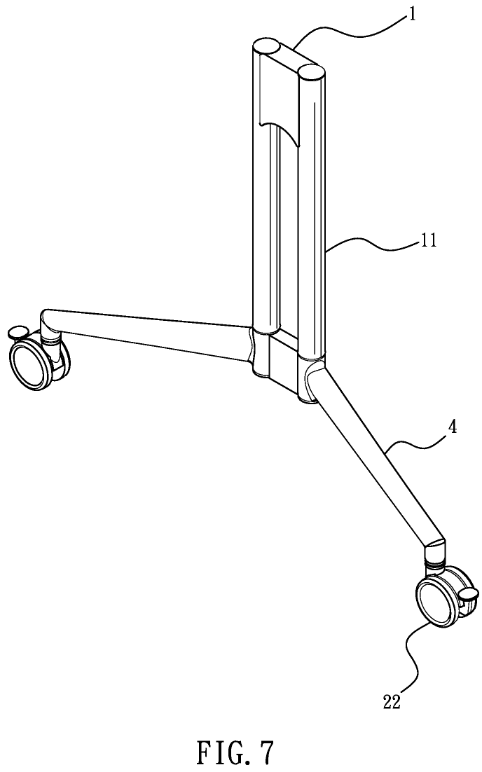

Referring to FIG. 7, a second embodiment of a table leg assembly in accordance with the present invention is illustrated. The elements and effects of the second embodiment which are the same with the first embodiment are not described, only the differences are described. The branch leg 4 of the second embodiment is longer than the branch leg 2 of the first embodiment for providing more stability than the first embodiment.

Although the invention has been explained in relation to its preferred embodiment, it is to be understood that many other possible modifications and variations can be made without departing from the spirit and scope of the invention as hereinafter claimed.

What is claimed is:

1. A table leg assembly comprising:
an upright leg having two tubes longitudinally extended therefrom, each tube having a joint member plugged into a lower end thereof, at least one positioning pin passed through the joint member; and
two branch legs connected to the upright leg, each branch leg having a cylinder formed in one end thereof, the cylinder being coaxially connected to the tube, the cylinder having multiple positioning holes defined therein;
wherein the at least one positioning pin is corresponding to one of the multiple positioning holes and plugged into the corresponding one of the multiple positioning holes.

2. The table leg assembly as claimed in claim 1, wherein the joint member has a stub extended therefrom, the stub plugged into the cylinder.

3. The table leg assembly as claimed in claim 2, wherein the cylinder has a receiving hole centrally defined therein for receiving the stub.

4. The table leg assembly as claimed in claim 1 further comprising two connecting pins, each connecting pin passed through the cylinder and plugged into the joint member for firmly connecting the branch leg and the tube.

5. The table leg assembly as claimed in claim 4 further comprising a joint plate disposed in a bottom of the cylinder and two screws, each screw passed the joint plate and fastened with one of the two connecting pins for securing the two branch legs.

6. The table leg assembly as claimed in claim 1, wherein each branch leg has a roller disposed in one end thereof opposite to the cylinder.
